(19) United States
(12) Patent Application Publication
(10) Pub. No.: US 2025/0239257 A1
(43) Pub. Date: Jul. 24, 2025

(54) Correcting Audio Drift

(71) Applicant: Apple Inc., Cupertino, CA (US)

(72) Inventors: John H. Lee, San Francisco, CA (US); John McAvey, Sunnyvale, CA (US); Mark B. Larus, San Francisco, CA (US); Robin Chou, Cupertino, CA (US); Zachary I. Porges, Sunnyvale, CA (US)

(21) Appl. No.: 18/420,461

(22) Filed: Jan. 23, 2024

(51) Int. Cl. G10L 15/08; G10L 15/02; G10L 15/04; G10L 15/30

(52) U.S. Cl. CPC G10L 15/08; G10L 15/02; G10L 15/04; G10L 15/30

(57) ABSTRACT

Audio media items with dynamic content are synchronized with a transcript by automatically generating, for a first version of an audio media item, a transcript, and an audio fingerprint indicative of audio characteristics of each of a set of segments of the first version of the audio media item. A playback device receives the transcript and the first audio fingerprint to a playback device and presents the transcript during playback of a second version of the audio media item in accordance with a comparison of the audio fingerprint and a second audio fingerprint for the second version of the audio media item.

### FIELD OF THE INVENTION

This disclosure relates generally to media playback and more specifically to providing a system and method for audio playback with correction for audio drift.

### BACKGROUND

Podcasts and other long-form audio formats have emerged as popular mediums for disseminating information and entertainment. They offer a wide range of content, from educational lectures to dramatic storytelling, often spanning substantial durations. Despite their rich and diverse content, the mechanisms for navigating these formats are typically limited to basic play, pause, rewind, and fast-forward controls. This poses a significant technical challenge, particularly when users wish to locate and share specific segments within these long-form media.

One of the primary challenges in this domain is the sharing of particular points within a podcast. The current state of the art does not provide an efficient means to do so, making it difficult for users to reference a specific discussion or topic. This issue is further complicated by the variable insertion of dynamic content within these formats. Dynamic content can vary in length and placement, disrupting the continuity of the content and make it even more challenging to pinpoint specific timestamps. The unpredictability of dynamic content insertions means that a user cannot reliably share a particular point in a podcast by simply providing a timestamp, as the actual content at that timestamp may differ between listeners. What is needed is a technique to offer a more user-friendly and efficient means of navigating and sharing content within podcasts and other long-form audio formats.

### BRIEF DESCRIPTION OF THE DRAWINGS

FIG. 1 shows, in block diagram form, a simplified network diagram according to one or more embodiments.

FIG. 2 shows, in flow diagram form, an example technique for providing a transcript and audio fingerprint to a client device, in accordance with one or more embodiments.

FIG. 3 shows, in flow chart form, an example method providing a transcript and audio fingerprint to a client device, according to one or more embodiments.

FIG. 4 shows, flow chart form, an example method for using an audio fingerprint to manage playback at a client device, in accordance with one or more embodiments.

FIG. 5 shows an example diagram of a user interface for managing playback of an audio item using a transcript, according to one or more embodiments.

FIGS. 6A-6C show, in flowchart form, example techniques for navigating an audio file using audio fingerprints, in accordance with one or more embodiments.

FIG. 7 shows in flow diagram form, an example technique for synchronizing audio items across audio devices using locally generated audio fingerprints, in accordance with one or more embodiments.

FIG. 8 shows, in flowchart form, a technique for generating a media guide using a transcript of an audio item and an associated audio fingerprint, in accordance with one or more embodiments.

FIG. 9 shows an example system diagram for an electronic device in accordance with one or more embodiments.

### DETAILED DESCRIPTION

This disclosure is directed to systems, methods, and computer media for managing and synchronizing audio media items having embedded dynamic content. In general, techniques are disclosed in which a media service can obtain an audio media item and generate an associated transcript, as well as an audio fingerprint for the media item. Playback devices can use the fingerprint and the transcript to navigate the audio media item.

According to one or more embodiments, a media service provider can obtain an audio item containing dynamic content from a content provider. The media service provider can then generate a transcript for the audio item. For example, the media service provider can use natural language processing, such as speech-to-text to generate a transcript of the media item. Thus, the transcript can include a text version of the content of the audio media item as received by the media service. In addition, media service provider can generate an audio fingerprint of the media item. The audio fingerprint may include a unique acoustic signature of the audio item. For example, the signature may capture the time frequency distribution of the audio signal energy. In some embodiments, audio signature may be determined for each of the set of segments of the audio item. As such, the audio signature may be associated with a mapping allowing a device to cross reference the audio signature to the audio item. In some embodiments, a timestamp will be associated with segments of the audio fingerprint, thereby providing a reference as to which portion of the audio item a particular segment of the audio fingerprint corresponds.

In some embodiments, the transcript and the audio fingerprint can be provided to a playback device. During playback of the audio media item, the transcript may be presented based on a current portion of the media item being played. However, because the audio media item may include dynamic content, the version of the audio media item which was used to generate transcript may not be identical to version of the audio media item played by the playback device. Thus, the portion of the content at one timestamp of one media item may differ from the portion of the content at the same time stamp at the other media item. For example, the dynamic content provided in the version of the media item obtained by the media service provider may differ from the dynamic content provided in the version media item obtained by the playback device during playback. Accordingly, embodiments described herein provide a technique for synchronizing the transcript generated from a first version of the audio media item with playback of the second version of the audio media item, particularly when dynamic content of the first and second versions of the audio media item differ.

According to one or more embodiments, the client device can identify a current moment of the audio playback. The current moment may be a portion of the local audio media item being played by the client device. The audio signature may be determined for the portion of the audio media item being played by the client device. That is, the client device may generate a local audio fingerprint based on the version of the media item at the client device. A matching process may be applied between the audio signature generated by the client device and an audio fingerprint receive from the media service. Based on the matching process, the portion of the transcript corresponding to the current moment may be determined. The corresponding portion of the transcript may then be presented and/or highlighted during playback of the current moment.

By comparing a locally generated audio fingerprint for one version media item with a received audio fingerprint of a second version of the media item, additional functionality is available to a client device. For example, a client device can share audio media item with another client device at a particular moment in the audio media item, even if a version of the media item at the local client device differs from a version of the media item at the remote device due to dynamic content. In particular, the local client device can share audio media item with a remote client device, along with a timestamp or other indication of a particular moment in the audio media item. Local client device can additionally determine an offset or other indication of the difference between the moment at the local device and the moment at a centralized server, such as the audio media service. The remote device can then determine its own audio fingerprint for the media item based on a local version of the audio media item. The remote device can then determine a difference between its own audio fingerprint with the server provided audio fingerprint, and initiate playback at a location and the local version of the media item based on the share request, as well as the difference between the sending device's audio media item and server provided media item, and the difference between the receiving devices media item and the server devices media item.

According to some embodiments, additional processing can be performed on the server provided transcripts to enable additional functionality. For example, one or more summaries can be generated from the transcript, and mapped to the associated audio fingerprints. By doing so, an audio media guide for the audio item can be generated and used by the client device to modify how the audio media item is played. In some embodiments, portions of the audio media item can be classified based on the one or more summaries such that the playback device can be classifications to modify playback, such as by prioritizing particular classifications of the audio media item segments, skipping or deprioritizing other classifications of the audio media item segments, or the like. Further, in some embodiments, a full summary of the media item can be generated. Further, if the audio media item as part of a collection of media items, such as an episode of a podcast or other episodic media item, the transcript of a particular episode can be used to generate a summary of the entire season or series of the collection of audio media items.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow chart may be presented in a particular order. However, it should be understood that the particular flow of any flow diagram is used only to exemplify one embodiment. In other embodiments, any of the various components depicted in the flow chart may be deleted, or the components may be performed in a different order, or even concurrently. In addition, other embodiments may include additional steps not depicted as part of the flow chart. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming but would nevertheless be a routine undertaking for those of ordinary skill in the art of image capture having the benefit of this disclosure.

For purposes of this disclosure, media items are referred to as “audio media items.” These audio media items may include, for example, podcasts, audio books, or other forms of audio media. In one or more embodiments, the media items referred to as “audio media items” could be any kind of media item that includes an audio component, such as video media items, podcasts, e-books, interviews, radio stations, as well as media items which include an audio component and a visual component such as videos, video podcasts, or the like.

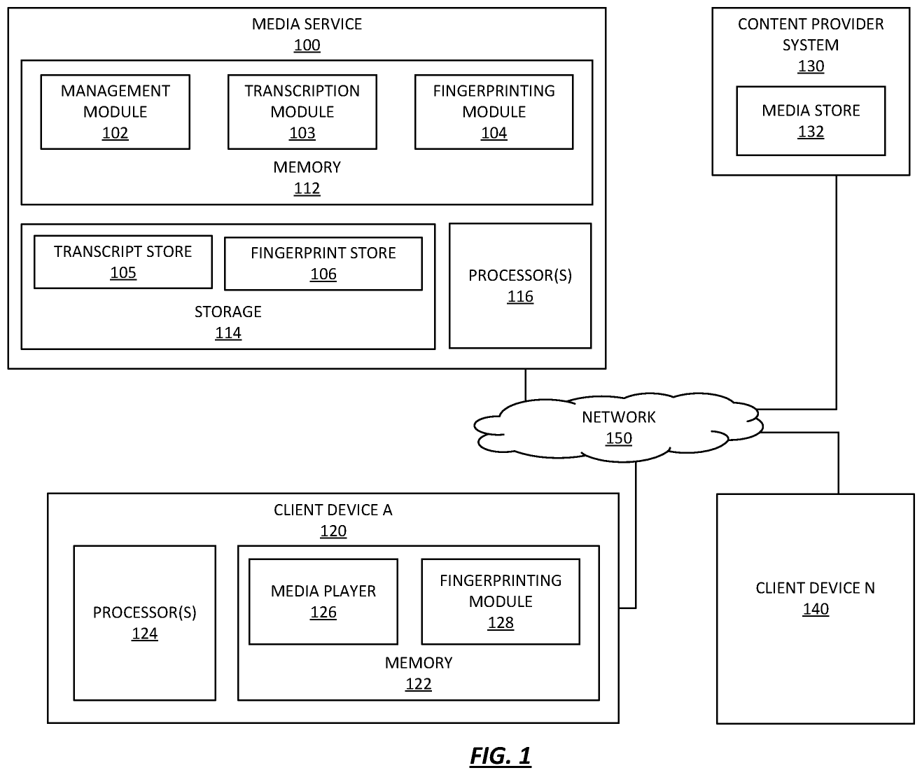

Referring to FIG. 1, a simplified block diagram is depicted of a media service 100 connected to a first client device A 120, and a second client device N 140, for example over a network 150. Each client device, such as client device 120 and client device N 140, may be a multifunctional device, such as a mobile phone, tablet computer, personal digital assistant, portable music/video player, wearable device, or any other electronic device that includes a media playback system. According to some embodiments, the media service 100 may additionally be communicably connected to a content provider, such as content provider system 130, which may host audio media items. For example, content provider system 130 may include one or more servers or network storage on which audio media items are hosted.

Media service 100 may include one or more servers or other computing or storage devices on which the various modules and storage devices may be contained. Although media service 100 is depicted as comprising various components in an exemplary manner, in one or more embodiments, the various components and functionality may be distributed across multiple network devices, such as servers, network storage, and the like. Further, additional components may be used, some combination of the functionality of any of the components may be combined. Generally, media service 100 may include one or more memory devices 112, one or more storage devices 114, and one or more processors 116, such as a central processing unit (CPU) or a graphical processing unit (GPU). Further processor 116 may include multiple processors of the same or different type. Memory 112 may each include one or more different types of memory, which may be used for performing device functions in conjunction with processor 116. For example, memory 112 may include cache, ROM, and/or RAM. Memory 112 may store various programming modules during execution, including management module 102, a transcription module 103, and a fingerprinting module 104.

According to one or more embodiments, the management module 102 may include computer code executable by processor(s) 116 to manage ancillary data for audio media items, for example media items provided by content provider system 130. For example, management module 102 may be configured to subscribe to content feeds provided by content provider system 130, or otherwise obtain media items provided by content provider system 130. The management module 102 may then process those media items to generate ancillary data to provide to client devices to enhance usability of the media items during playback and functionality of a media player. For example, management module 102 may work in concert with transcription module 103 to generate a transcription of an audio item provided by content provider system 130. The transcription module 103 may provide a method for ingesting an audio media item and generating a transcript of the audio media item. For example, the transcription module 103 may use speech-to-text functionality or other language processing functionality to generate a transcript of the episode. And some embodiments, the transcript may be mapped to the audio media item, for example using timestamps or other identifiers to indicate a temporal relationship between the transcription and the audio media item from which the transcription was generated. Further, memory 112 may include a fingerprinting module 104, which may work in concert with management module 102 to generate an audio signature of an ingested audio media item. The fingerprinting module 104 can determine a unique acoustic signature of the audio item. For example, the signature may capture the time frequency distribution of the audio signal energy. In some embodiments, audio signature may be determined for each of the set of segments of the audio item. The audio signature may be associated with a mapping allowing a device to cross reference the audio signature to the audio item. In some embodiments, a timestamp will be associated with segments of the audio fingerprint, thereby providing a reference as to which portion of the audio item a particular segment of the audio fingerprint corresponds. In some embodiments, the audio signature may be determined for the entire audio media item. Alternatively, audio signatures may be determined for samples or segments of the audio media item. Although the management module 102, transcription module 103, and fingerprinting module 104 are depicted as separate modules, it should be understood that the functionality of the management module 102, transcription module 103, and fingerprinting module 104 may be differently distributed. For example, in some embodiments, the transcription module 103 and the fingerprinting module 104 may be part of the management module 102.

According to some embodiments, the management module 102 may have additional functionality. For example, the management module 102 may generate summaries of the audio media item based on the transcription provided by the transcription module 103. For example, the summaries may include a shortened version of the entire episode, shortened versions of excerpts of the audio item, or the like. In some embodiments, the management module 102 may map the summaries to the audio media item, for example using timestamps, the transcript, the audio fingerprint, or the like. Thus, the summaries may be used to provide a guide to a particular audio media item or collection of audio media items. In one or more embodiments, the summaries may additionally or alternatively be used to classify audio content. For example, based on the transcript and/or the summaries, a determination can be made as to which portions of an audio media item are more relevant than others for example, based on subject matter, audio quality, for the like. The summaries or other associated content may additionally or alternatively be provided to the client device and may optionally be used to adjust playback. For example, the media player 126 can present summary of an audio media item for selection by a user for playback. As another example, the media service 100 and/or the client device 120 may generate previews of a media item by generating a variation of the media item which omits content which is considered to be irrelevant or fails to satisfy a relevancy criterion.

Media service 100 may store data related to media items, for example in storage 114. According to one or more embodiments, storage 114. Storage 114 may include, for example, a transcript store 105, in which transcripts generated from received media items are stored. In addition, storage 114 may include a fingerprint store 106, in which audio fingerprints for received media items are stored. According to one or more embodiments, the stored transcripts and the stored audio fingerprints may be stored in a data structure such that the corresponding counterparts are evident in the storage system.

Content provider system 130 may include, for example, media files, media file data, podcast catalog data, e-book catalog data, information regarding, for example, songs, albums, artists and creators, publishers, or the like, for example in media store 132. Content provider system 130 may store information regarding the media items, such as metadata which may be transmitted along with the media item for processing or playback of the media item. According to one of embodiments, content provider system 130 may provide audio media items having dynamic content. That is, content provider system 130 may provide audio media items which include a static portion, which is present among all instances of the media item provided to other devices. The audio media items may also include a dynamic portion, which may differ among versions of the media item provided by the content provider system 130. The dynamic portions may include audio content interspersed in the audio media item, and the location and duration of the dynamic content may differ from one iteration of the audio media item to another. As such, two devices receiving a same audio media item from the content provider system 130 may receive two different audio files such that the content of the audio files is out of sync.

According to some embodiments, client devices may receive media items and ancillary data for the media items from the content provider system 130 and/or the media service 100. Client device A 120 is shown as an example. Client device A 120 includes, for example, one or more processors 124. Processors may include, for example, a central processing unit (CPU) or a graphical processing unit (GPU). Further, processor 116 may include multiple processors of the same or different type. Client device A 120 may additionally include a memory 122. Memory 122 may each include one or more different types of memory, which may be used for performing device functions in conjunction with processor 124. For example, memory 122 may include cache, ROM, and/or RAM. Memory 112 may store various programming modules during execution, including media player 126, and fingerprinting module 104.

According to one more embodiment, the media player 126 may be an executable module on memory 122 which is configured to provide functionality for obtaining and playing audio content and/or other media items having an audio component. In some embodiments, the media player 126 can receive an audio media item from content provider system 130. In some embodiments, the media player 126 can additionally receive ancillary data for the media item from the media service 100. For example, the client device A 120 can obtain an instance of a media item from content provider system 130 and receive corresponding audio fingerprint data and transcription from media service 100.

Because audio media items received from content provider system 130 may differ between instances, the version of the media item received by client device A 120 may differ from the version of the audio media item processed by media service 100 to generate the transcript and the audio fingerprint. Accordingly, client device A 120 may include a local fingerprinting module 128. The local fingerprinting module 128 may generate an audio fingerprint based on the received version of the audio media item from the content provider system 130. The media player 126 can then compare the locally generated audio fingerprint to the audio fingerprint received from media service 100 in order to synchronize the transcript to the local version of the media item during playback. As such, the media player 126 may include a user interface which can present the transcript during playback such that the presentation of the transcript follows the playback of the audio media item.

As shown in the example network diagram, multiple client devices may be communicably connected across the network 150, such as client device A 120 and client device N 140. It should be understood that client device N 140 may include similar components to those described above with respect to client device A 120. Thus, client device N 140 can also receive versions of the particular audio media item from content provider system 138, and the audio media item received by client device N 140 may be out of sync with versions of the audio media item received by media service 100 or client device A 120. Similar to client device A 120, client device N 140 can synchronize playback of the received version of an audio media item with a transcript from the media service based on a locally generated audio fingerprint.

According to some embodiments, by generating audio fingerprints at each client device, the client devices can include functionality for sharing audio media items at particular moments within the audio media item even if the media item is not synced across devices due to embedded dynamic content. As will be described in greater detail below, client device a 120 can share a particular audio media item provided by content provider system 130 with client device N 140 at a particular moment in the audio media item. This particular moment may be associated with the local timestamp at client device a 120, which may differ from the moment at the same time stamp for the version received at client device N 140 due to the embedded dynamic content. Accordingly, client device A 120 may provide synchronization data based on a locally generated audio fingerprint for the audio media item when sharing the media item with client device N 140. In some embodiments, client device A 120 can compare a temporal difference between the moment in the local version of the audio media item with a version of the audio media item from media service 100. For example, client device A 120 may determine a temporal difference between the moment in the local version of the audio media item and the processed version of the media item by media service 100 by comparing an audio fingerprint at the moment with a temporal location of the matching portion of the audio fingerprint received from the media service 100. In some embodiments, client device N 140 may then use the synchronization data received from client device A 120 to determine a local difference between a local audio fingerprint and the server generated audio fingerprint provided by media service 100. The client device in 140 can then initiate playback at a time in the audio media item based on the difference between client device A 120 and media service 100, and the difference between client device N 140 and media service 100.

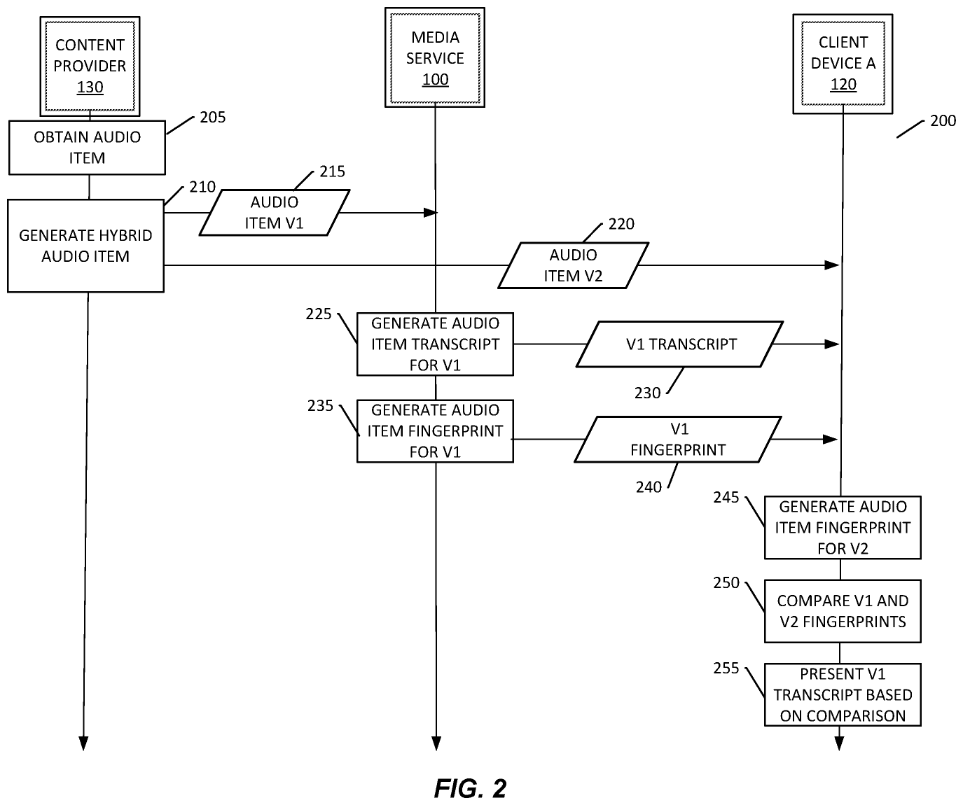

FIG. 2 illustrates an example flow diagram for an example technique for providing a transcript and audio fingerprint to a client device, in accordance with one or more embodiment. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added.

The flow diagram 200 presents an example flow for providing a transcript to a client device A 120 which has been generated from a different version of an audio item than the audio item received by the client device A 120. The flow diagram begins with content provider 130 obtaining an audio item at block 205. The audio item may be obtained by the content provider 130, for example, by the media service receiving an audio item from a content creator, an agent of a content creator, a producer of the content, or the like. As described above, the content may include an audio media item or a media item that includes an audio component. Examples of audio media items may include audio interviews, news items, e-books, or the like. In some embodiments, the audio media item may be one of an episodic series of audio media items, such as a podcast, an audio series, or the like. The content provider 130 may be a platform which provides the audio media item to subscribers, such as media services, playback devices, or the like.

The flow diagram 200 proceeds to block 210, where the content provider 130 generates a hybrid audio item from the obtain audio item. As an example, the content provider 130 may insert dynamic content into the audio media item. The dynamic content inserted within each instance of the audio media item provided to a receiving device may differ. The dynamic content may differ not only in placement within the item, but by duration, frequency of appearance, and the like. Accordingly, two instances of an audio media item provided by the content provider 130 can have different characteristics, such as different lengths, different file sizes, and the like. Further, the audio itself may differ between iterations of the provided version of the media item. For example, the content at a particular time stamp in one version may differ from the content at the same time stamp in another version. In the example shown in flow diagram 200, the content provider 130 can generate a first version of an audio media item 215 for transmission to media service 100, and a second version of the audio media item 220 to provide to client device A 120. As described above, audio item V1 215 and audio item V2 220 may correspond to a same audio media item but may include differing dynamic content. Said another way, the content of audio item V1 215 and audio item V2 220 may not be identical. However, static content for the audio media item may be present in both audio item V1 215 and audio item V2 220, although the static content may be located at different timestamps or other temporal locations within the corresponding versions of the media item, may have differing durations, or the like.

The flow chart proceeds to block 225, where the media service generates an audio item transcript for the audio item V1 215. As described above, the media service 100 may utilize speech-to-text to generate a transcript of the version of the audio item received as audio item V1 215. In some embodiments, the generated transcript may be mapped to the audio media item, for example, using timestamps corresponding to audio item B1 215, or the like. In addition, at block 235, media service 100 can generate an audio item fingerprint for V1. The media service 100 can generate the audio item fingerprint to generate signatures for the audio item V1 215. For example, a single audio item fingerprint may be generated for the entire audio item. Alternatively, multiple individual audio item fingerprints can be generated for one or more segments of the audio item V1 215. According to some embodiments the one or more audio item fingerprints can be mapped to the audio item B1 215 using timestamps or other indicators of a temporal position of the audio media item corresponding to a particular audio item fingerprint or portion of the audio item fingerprint.

The media service 100 may provide the V1 transcript 230 and V1 fingerprint 240 to client device A 120. In some embodiments, the client device A 120 can subscribe to particular content from a content provider 130. The client device A 120A can indicate these subscriptions to the media service 100 such that when content is available from the content provider 130, the media service can provide the associated ancillary data for the media item content such as the V1 transcript 230. Alternatively, when client device A 120 requests an audio item from content provider 130, client device A 120 can notify the media service 100 to obtain any ancillary data for the requested media item generated by the media service 100, such as V1 transcript 230.

Upon receiving the audio item V2 220, the V1 transcript 230, and V1 fingerprint 240, the client device A 120 can provide the audio item V2 220 for playback along with the V1 transcript 230 for presentation on a user interface. According to embodiments, the client device A 120 synchronizes the V1 transcript 230 with the audio item V2 220 by generating an audio item fingerprint for V2, as shown at block 245. As described above, because the content within audio item V1 215 and the content of audio item V2 220 may differ due to dynamic content embedded therein, the audio item fingerprint generated by client device a based on audio item V2 220 may differ from the V1 fingerprint 240 received from content provider 130, which was generated based on audio item V1 215.

At block 250, client device a 120 compares the V1 fingerprint 240 and the fingerprint for V2 generated at block 245. In some embodiments, the fingerprints are compared during playback, and in accordance with the presentation of the V1 transcript, such that the V1 transcript 230 is presented based on the comparison, as shown at block 255. In one example, as a particular word or segment of the audio item V2 220 is played at client device A 120, a corresponding portion of the V2 fingerprint maybe generated or obtained. This portion of the V2 fingerprint may be compared against the V1 fingerprint to determine a timestamp or other temporal marking for the V1 media item from which the V1 transcript was generated. Accordingly, the timestamp or other temporal marking may be used to cross reference the V1 transcript 230 to determine a portion of the transcript to present at client device a 120. Notably, because the transcript was generated from a media item which may include dynamic content, it is possible that the transcript includes text that corresponds to content not found in the local media item. By using the locally generated audio fingerprint to reference the transcript, these portions of the transcript can be omitted or skipped over, according to one or more embodiments. Further, in some embodiments, the portions may be replaced with other content or interface components, such as an animation.

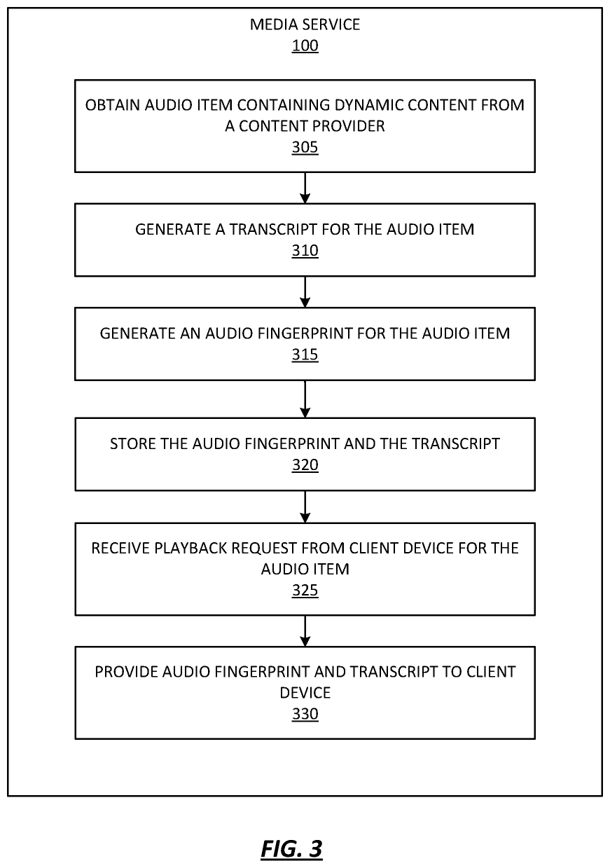

FIG. 3 shows, in flow chart form, an example method providing a transcript and audio fingerprint to a client device, according to one or more embodiments. The various processes are described as being performed by media service 100. However, it should be understood that the various process can be performed by additional or alternative devices. Further, in some embodiments, the various processes could be performed by different devices of media service 100. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added.

The flow chart begins at block 305, where an audio item is obtained that contains dynamic content. The audio item may be obtained, for example, from a media platform configured to host audio items for distribution to one or more playback devices. For example, for the content provider may include network storage, the cloud system, or the like which is configured to host media items containing an audio component. The audio item may be obtained automatically, or upon request from the media service 100. The audio item may contain dynamic content which is generated prior to the audio item being provided to the media service 100. The dynamic content may include, for example, ancillary information about the media item, independent content interspersed within the audio item comment or the like.

The flow chart proceeds to block 310, where a transcript is generated for the audio item. According to one or more embodiments, the transcript may be generated by the media service 100 by applying speech-to-text processing to the audio item. And some embodiments, additional or alternative processing, for example using machine learning models, may be applied to generate a transcript for the media item. The transcript may include, for example, a word-for-word representation of the content of the audio media item. In some embodiments, the transcript may additionally include a mapping indicating a temporal guide between the transcript and the audio item. For example, timestamps may be used to indicate a portion of the audio item corresponding to a particular portion of the transcript.

At block 315, an audio fingerprint is generated for the audio item. As described above, the audio fingerprint may comprise a unique acoustic signature of all or part of an audio media item. The signature may be obtained by applying the audio media item to a model or network which is trained to generate one or more audio signatures for the audio media item. In some embodiments, the audio fingerprint may capture a time-frequency distribution of the audio signal energy. Further, in some embodiment, the audio fingerprint may be a compact representation of the unique audio characteristics of the audio item, thereby reducing bandwidth requirements. In some embodiments, the audio fingerprint may be generated for the entire audio media item. Additionally, or alternatively, audio fingerprint data may be generated for segments or samplings of the audio media item. In some embodiments, the audio fingerprint may additionally include a mapping indicating a temporal guide between the transcript and the audio item. For example, timestamps may be used to indicate a portion of the audio item corresponding to a particular portion of the audio fingerprint. At block 320, the audio fingerprint and the transcript are stored by the media service 100.

The flow chart proceeds to block 325, where a playback request from a client device is received for the audio item. The playback request may indicate that the client device intends to play the audio item (which, as described above, may be received by the client device from a separate source). Alternatively, the playback request may indicate that the client has received or will receive the media item from a content provider. The flow chart concludes at block 330, where the media service 100 provides the audio fingerprint and the transcript to the client device. As described above, the audio fingerprint and the transcript have been generated based on the audio item obtained at block 305, which may differ with respect to dynamic content from a version of the audio item for which the audio fingerprint and transcript will be used at the client device.

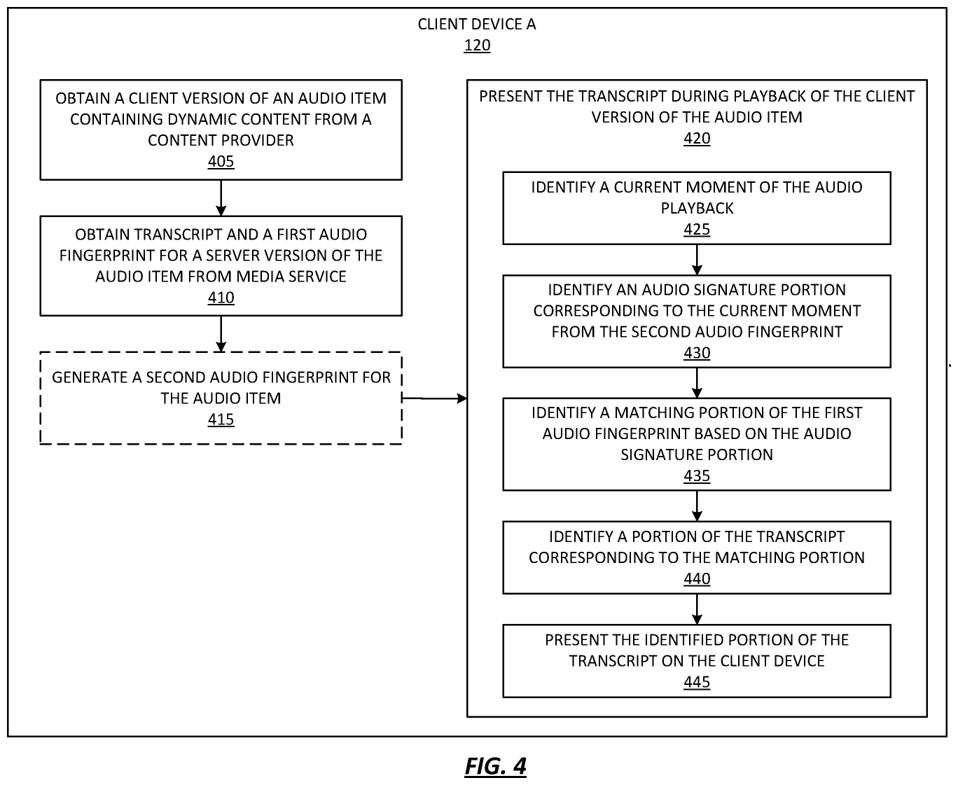

By providing the server-generated transcript and audio fingerprint to the client device, additional functionality is enabled on the client device. For example, the transcript can be synchronized to the playback on the client device. FIG. 4 shows, flow chart form, an example method for using an audio fingerprint to manage playback at a client device, in accordance with one or more embodiments. The various processes are described as being performed by client device A 120. However, it should be understood that the various process can be performed by additional or alternative devices. Further, in some embodiments, the various processes could be performed by different devices communicably connected to client device A 120. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added.

The flow chart begins at block 405, where the client version of audio media item is obtained. The audio item may be obtained, for example, from a media platform configured to host audio items for distribution to one or more playback devices. For example, for the content provider may include network storage, the cloud system, or the like which is configured to host media items containing an audio component. The audio item may be obtained automatically, or upon request. The client version of the audio media item may be same audio media item as described above with respect to FIG. 3. However, because the media item includes dynamic content, the version of the media item received at the client device A120 may differ from the version of the media item processed by media service 100.

The flow chart proceeds to block 410, where a transcript and the first audio fingerprint are obtained from the media service 100. As described above, the transcript and the first audio fingerprint are generated from a server version of the audio media item, which may differ from the client version of the audio media item obtained at block 405. Further, as described above, the transcript may include a text representation of the content of the audio media item, whereas the audio fingerprint may include a representation of audio characteristics of one or more portions of the audio media item. According to some embodiments, each of the first audio fingerprint and the transcript may include temporal information, such as timestamps, from which the transcript on the first audio fingerprint can be cross referenced.

The flow chart proceeds to block 415, where the client device A 120 optionally generates a second audio fingerprint for the audio item. According to one or more embodiments, the second audio fingerprint is generated to represent audio characteristics of the client version of the audio item. As such, the first audio fingerprint and the second audio fingerprint may differ. In some embodiments, the client device A 120 generates the second audio fingerprint upon receiving the audio media item. Alternatively, the client device A 120 may generate the second audio fingerprint dynamically during playback. As such, the entire audio fingerprint for media item may be predetermined by the client device A 120 or may be determined in portions. Further, in some embodiments, the client device A 120 may generate audio fingerprints for particular segments or selections of the audio item.

The flow chart proceeds to block 420, where the client device A 120 presents the transcript during playback of the client version of the audio item. According to one or more embodiments, the transcript may be presented in portions in accordance with a current temporal state of the client version of the audio media item. As such, the flow chart includes, at block 425, identifying a current moment of the audio playback. The current moment may be a particular segment of the client version of the audio item currently playing, about to be played, or the like. At block 430, an audio signature is identified for the portion corresponding to the current moment from the second audio fingerprint. If the audio fingerprint was generated at block 415, the audio signature portion corresponding to the current moment may be identified within the second audio fingerprint. Alternatively, if the audio fingerprint is generated dynamically during playback, then an audio signature for the identified current moment may be generated.

The flow chart continues at block 435, where a matching portion of the first audio fingerprint is identified based on the audio signature portion. That is, the identified portion from the second audio fingerprint provides a representation of the audio characteristics of the moment. By comparing the representation of the moment from the second audio fingerprint to the first audio fingerprint, a matching portion of the first audio fingerprint can be identified. Then, at block 440, a portion of the transcript corresponding to the matching portion of the first audio fingerprint can be identified. That is, because the transcript and the first audio fingerprint are generated from the same version of the audio media item, the temporal demarcations, such as timestamps or the like in each of the transcript and the first audio fingerprint, can be used to cross reference from the matching portion of the first reading fingerprint to the transcript to identify a portion of the transcript corresponding to the matching portion of the first audio fingerprint, thereby corresponding to the current moment of the audio playback of the second version of the audio item.

The flowchart concludes at block 445, where the identified portion of the transcript is presented on the client device. In some embodiments, a user interface may be presented on the client device during playback of the media item which provides functionality for user to interact with the audio media item. In some embodiments, the user interface may include a transcript component, which presents the portion of the transcript that matches a current moment being played during playback.

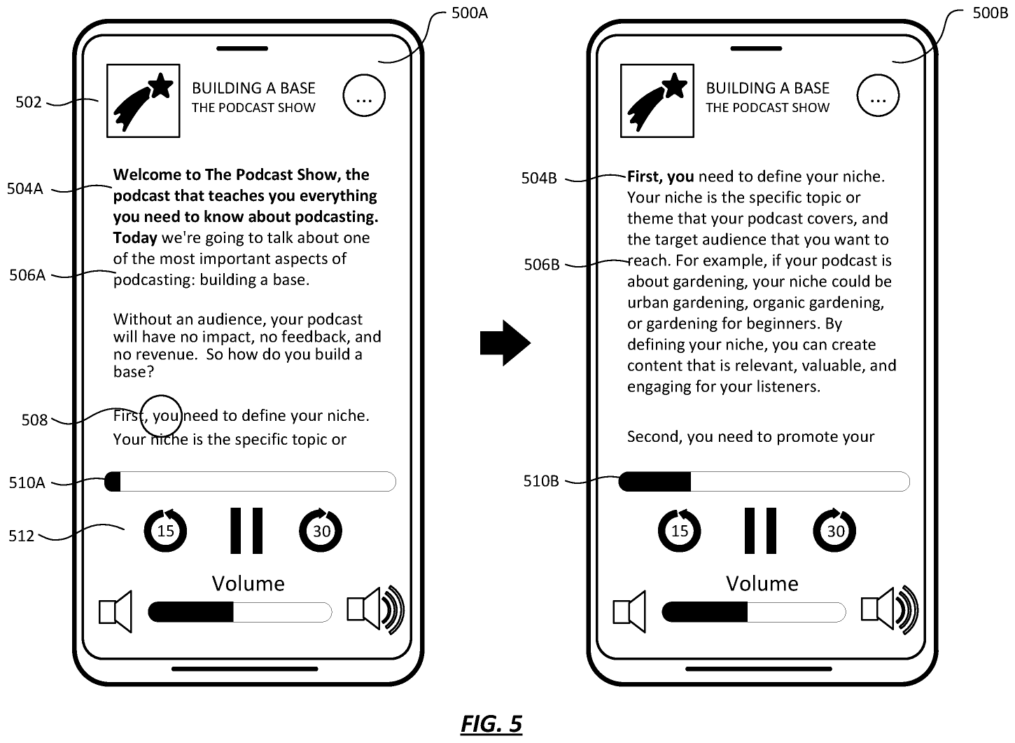

FIG. 5 shows an example diagram of a user interface for managing playback of an audio item using a transcript, according to one or more embodiments. Specifically, FIG. 5 illustrates a multifunctional device having a touch screen that displays media content, such as within media player 126 of FIG. 1.

As shown in interface 500A, the media player may generate a graphical user interface that includes a graphical depiction 502 for one or more media items. Graphical depictions may include media art or a depiction of the artist. The user interface may additionally include a portion of the interface including a duration bar 510A that shows a current playback position of the audio item. The user interface may include additional components for managing playback, including playback controls 512, such as pause, rewind, or fast-forward of the media item during playback.

According to one or more embodiments, the user interface may include a region dedicated to presenting the transcript for the media item during playback. In some embodiments, the transcript may be presented using different formatting depending on the current portion of the transcript that corresponds to a current moment in the media item. As shown in interface 500A, a first portion 504A of the text of the transcript indicates a portion have the audio media item which has been played, or which is prior to a current playback position. A second portion 506A of the transcript is indicative of upcoming content during playback of the media item and is made apparent by a different formatting than the first portion 504A.

According to some embodiments, a user may manipulate playback of the audio media item by interacting with the transcript. As shown at 508, a user can select a portion of the transcript to cause the corresponding portion of the audio media item to be played. For purposes of this example, if a user selects portion 508 in interface 500A, then the playbook of the audio media item and the corresponding components in the user interface may be updated, as shown in user interface 500B. For example, the selected text from 508 now appears at the top of the transcript portion of the interface. In addition, the first portion 504B now shows that the selective portion has been played or is currently being played. In addition, the second portion 506B now shows a portion of the transcript following the selected portion, which is upcoming during playback. The revised playback is also indicated by the duration bar 510B, which shows that the playback position is further into the audio media item then at 510A.

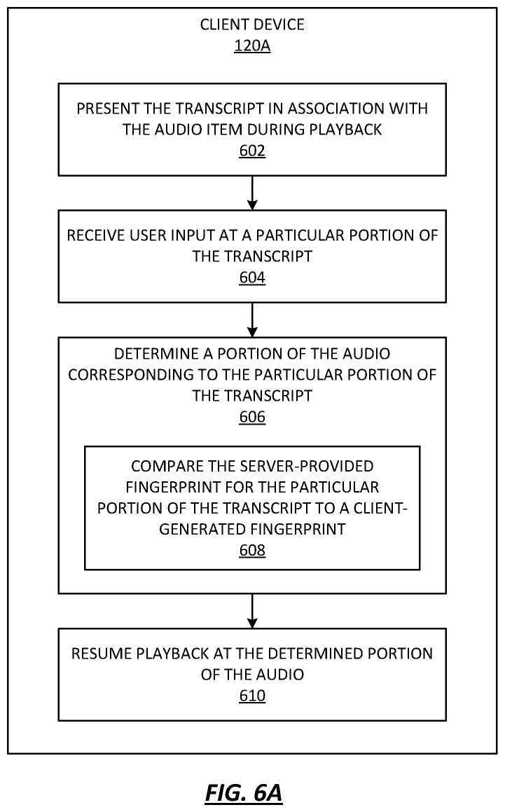

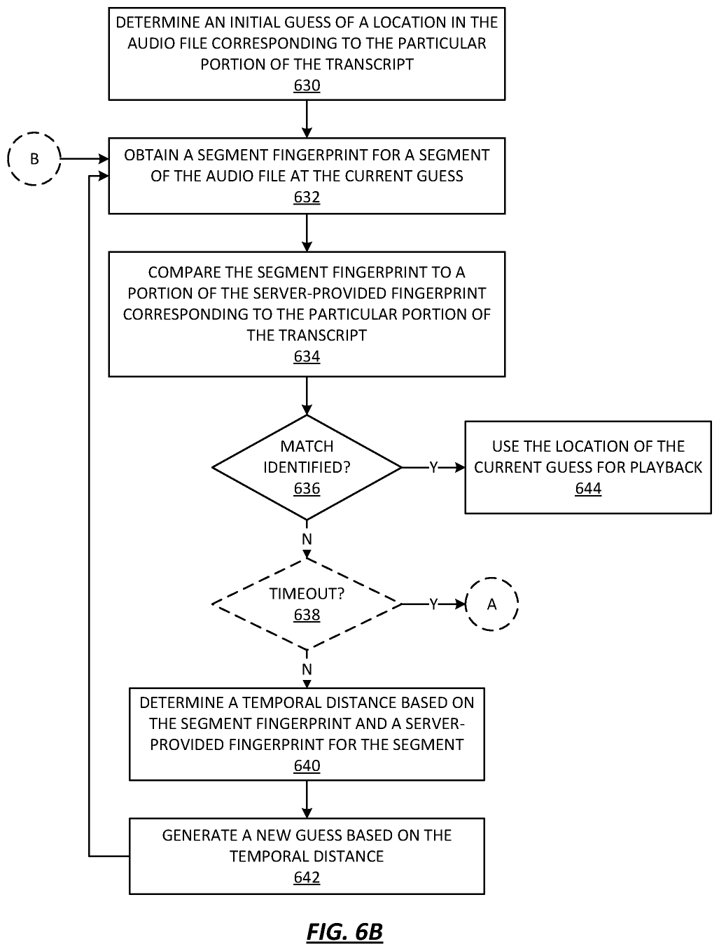

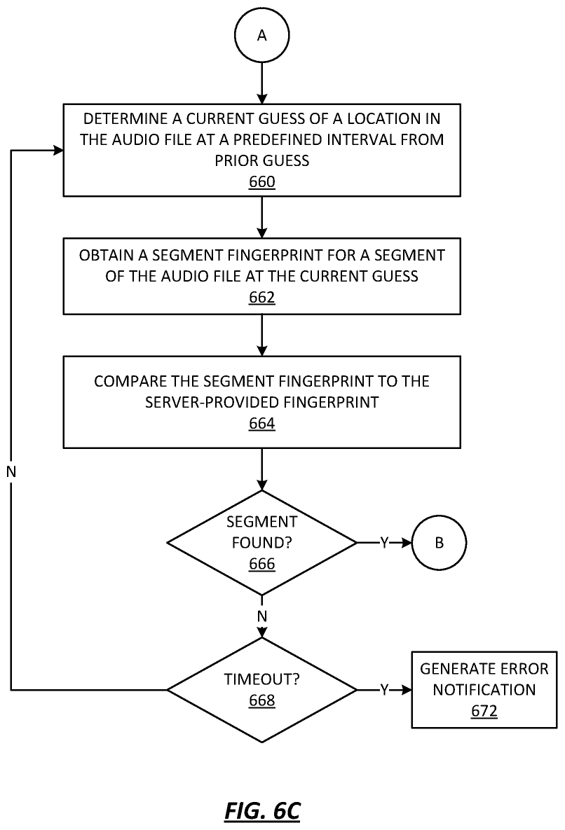

FIGS. 6A-6C show, in flowchart form, example techniques for navigating an audio file using audio fingerprints, in accordance with one or more embodiments, as described above with respect to FIG. 5. The various processes are described as being performed by client device A 120. However, it should be understood that the various process can be performed by additional or alternative devices. In addition, the various actions may be performed in a different order. Further, some actions may be performed simultaneously, and some may not be required, or others may be added.

The flow chart in FIG. 6A begins at block 602, where the transcript is presented in association with the audio item during playback of the audio item. As described above with respect to FIG. 5, the transcript may be presented in a particular region of the display within the user interface associated with the media player application. In some embodiments, the transcript may be presented prior to playback, or upon initiating playback of the media item.

The flow chart proceeds to block 604, where user input is received at a particular portion of the transcript. For example, referring back to FIG. 5, user input 508 may be associated with particular word, phrase, or the like in the transcript. Then, at block 606, a portion of the audio corresponding to the particular portion of the transcript is determined. As described above, because the version of audio media item being played may differ from the version of the audio media item from which the transcript was generated due to dynamic content comma the client device A 120 may rely on audio characteristics of the audio media item to determine the corresponding version of the local version of audio media item with respect to the selective portion of the transcript. As shown at block 608, the server provided fingerprint for the particular portion of the transcript may be compared to a client generated fingerprint. The process for comparing the server provided fingerprint with the client generated fingerprint will be described in greater detail below with respect to FIG. 6B and FIG. 6C.

The flow chart concludes at block 610, where playback is resumed at the determined portion of the audio media item. In particular, the media player 126 resumes playback of the local version of the media item at a location which is determined to correspond to the selected portion of the transcript. In some embodiments, additional updates may be presented on the user interface indicative of the resumed playback position. For example, the formatting of the text of the transcript may be updated, a portion of the transcript being displayed for placement of the transcript on the display may be updated, or the like.

The process for determining the playback position at the current device based on the selected portion of the transcript may be difficult, particularly if the entire fingerprint is unavailable at the local device. This may occur, for example, if the fingerprint for the local version of the media item is generated dynamically during playback. Generating the fingerprint dynamically during playback maybe useful to conserve compute resources, particularly if multiple audio media items are obtained by the client device within a short period of time.

The flow chart of FIG. 6B represents processes which may be performed with respect to determining a portion of the audio corresponding to the particular portion of the transcript as described at block 606 above with respect to FIG. 6A. The flowchart of FIG. 6B begins at block 630, where an initial guess is determined for location in the local audio file for a local version of the media item corresponding to the particular portion of the transcript. The initial guess may be constructed in a number of ways. For example, the initial guess may be based on a timestamp of the current playback position of the local version of the audio media item. As another example, the initial guess may be based on predetermined characteristics of the local version of the audio media item for example, based on prior interaction of the user with the media item, the client device may determine some indication of a temporal offset between the local version of the media item and the server version of the audio media item.

The flow chart proceeds to block 632, where a segment fingerprint is obtained for a segment of the audio media item at the current guest. In some embodiments, the audio fingerprint may be generated for a snippet of the media file around the first guest. For example, the segment may be of a predetermined size or duration. Further, and some embodiments, the segment may begin at the initial guess location, or may use the initial guess location as a median position for the segment.

At block 634, the segment fingerprint is compared to a portion of the server provided fingerprint corresponding to the particular portion of the transcript. The comparison of the segment fingerprint may include determining a similarity value, the likelihood of a match, or the like. At block 636, a determination is made as to whether a match is identified. In some embodiments, a match may be identified based on weather at least part of the segment fingerprint and at least part of the server provided fingerprint satisfy a match criterion. The match criterion may indicate, for example, a threshold similarity value, threshold likelihood of a match, or the like. If at block 636 a match is identified, then the flow chart concludes at block 644, and a location of the current guess is used for playback.

Returning to block 636, if a match is not identified, then optionally, the flow chart proceeds to block 638, where a timeout determination is made. If a timeout determination is made, then the flow chart proceeds to FIG. 6C, which will be described in greater detail below. If a timeout is not detected at block 638, or if the timeout decision is ignored, then the flow chart proceeds to block 640.

At block 640, the temporal distance is determined based on the segment fingerprint and the server provided fingerprint for the segment. The temporal distance may be determined, for example, based on timestamps or other temporal indications mapping a portion of the segment within the local audio file and a corresponding portion of the server provided fingerprint that matches the segment. The flow chart then concludes at block 642, where a new guess is generated based on the temporal distance. The flow chart then returns to block 630, and a new segment fingerprint is obtained for the segment of the audio file at the new guests. The process proceeds until the match is identified at block 636, and the location of the current guess when the match is identified is used for playback.

Returning to block 638, in some instances, it may occur that a match cannot be identified using the technique provided above with respect to FIG. 6B. For example, if a segment of an audio file at the current guess falls within dynamic content, no match may be identified at block 636. Thus, at block 638, a timeout determination may be made. This may happen, for example, because the dynamic content may be substantially long such that the match cannot be found. Accordingly, to find a match, a portion of the media item must be probed further away from the initial match. Thus, if a timeout condition exists, then the flow chart proceeds off page to FIG. 6C.

Turning to FIG. 6C, a technique for dynamic content recovery heuristic is provided. The technique begins at block 660, where the current guess location is determined in the audio file at a predefined interval from a prior guess. The predefined interval may be sufficiently long so as to reduce a number of iterations required to find static content in the media item. For example, if the dynamic content ranges from 30 seconds to 5 minutes, a 90 second interval may be used. Thus, a current guess may be determined using the latest guess from FIG. 6B, and the predefined interval.

The flow chart proceeds to block 662, where a segment fingerprint is obtained for a segment of the audio file at the current guess. The segment fingerprint is obtained, for example, using a local fingerprinting module. In some embodiments, the segment fingerprint may be generated for a snippet of the media file around the current guess. For example, the segment may be of a predetermined size or duration. Further, and some embodiments, the segment may begin at the current guess location, or may use the current guess location as a median position for the segment.

At block 634, the segment fingerprint is compared to a portion of the server private fingerprint corresponding to the particular portion of the transcript. The comparison of the segment fingerprint may include determining a similarity value, the likelihood of a match, or the like. At block 636, a determination is made as to whether the segment is bound in the received audio fingerprint from the media service. In some embodiments, a segment may be determined to be found if the segment satisfies a match criterion with a portion of the received audio fingerprint. The match criterion may indicate, for example, a threshold similarity value, threshold likelihood of a match, or the like. If at block 666 the segment is found, then the flow chart returns to FIG. 6B at block 632, and the matched location is used as a current guess.

Returning to FIG. 6C, if a segment is not found, then the flow chart proceeds to block 668 and a determination is made as to whether a timeout condition is satisfied. According to one or more embodiments, the timeout condition may be the same timeout condition as that described above with respect to decision block 638 of FIG. 6B. Alternatively, the timeout condition at block 668 may be different. The timeout condition may be satisfied, for example, after a predefined amount of time has passed since a match has been found, after a predefined number of unsuccessful iterations for generating guesses, or the like. If the timeout condition is satisfied at block 668, then the flow chart concludes at block 672, and an error notification is generated. In some embodiments, the error notification may indicate that a portion of the media item corresponding to the selected portion of the transcript cannot be found.

Returning to block 668, if the timeout condition is not satisfied, then the flow chart proceeds to block 670, and a new guess is generated based on the current guess and the predefined interval. In some embodiments, the new guess may be determined at a temporal location in the audio file that is the predefined interval from the prior guess. The flowchart then returns to block 660, and the process continues until a segment is found at block 666, or until a timeout condition is satisfied at block 668.

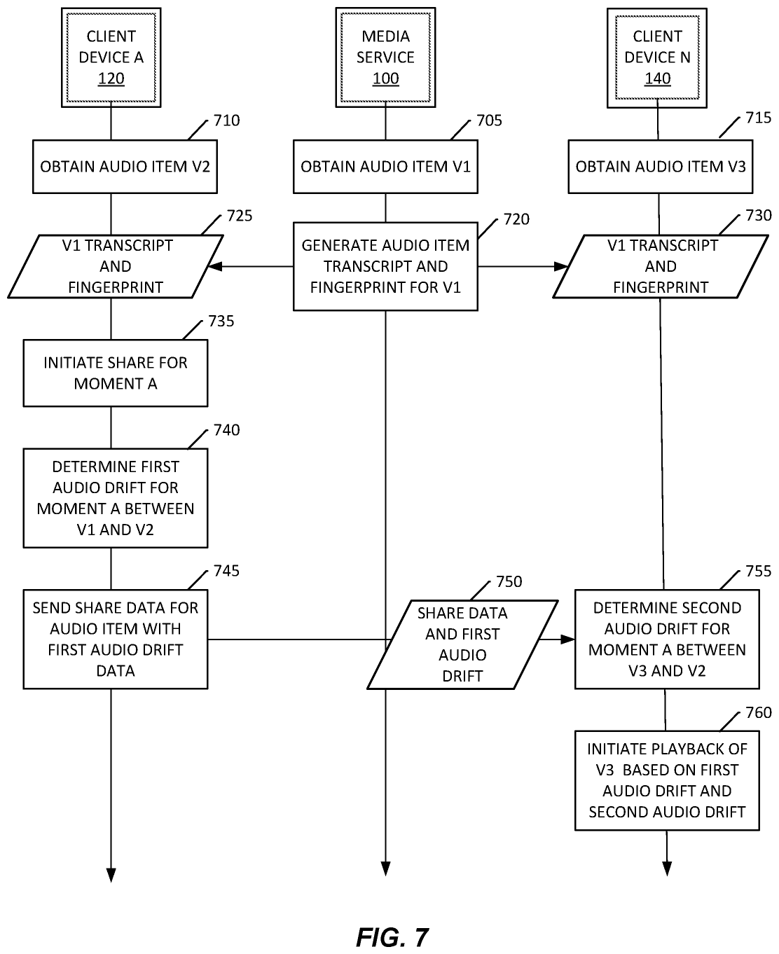

By comparing a locally generated audio fingerprint for one version media item a received audio fingerprint corresponding to a second version of the media item, additional functionality is available. For example, a client device can share the audio media item with another client device at a particular moment in the audio media item, even if a version of the media item at the local client device differs from a version of the media item at the remote device due to dynamic content. FIG. 7 shows in flow diagram form, an example technique for synchronizing audio items across audio devices using locally generated audio fingerprints, in accordance with one or more embodiments. For purposes of explanation, the following steps will be described in the context of FIG. 1, and in particular among client device A 120, media service 100, and client device N 140. However, it should be understood that the various actions may be taken by alternate components. In addition, the various actions may be performed in a different order. Further, some actions may be performed simultaneously, and some may not be required, or others may be added.

The flow diagram begins at block 705, where the media service 100 obtains a version one (“V1”) of an audio item. In addition, at block 610, client device A 120 obtains a second version (“V2”) of the same audio item, and at block 715, client device N 140 obtains a third version (“V3”) of the audio item. For purposes of the example, the audio item may be a hybrid audio item which contains static content and dynamic content. The various versions of the audio item may be obtained from a single source or from different sources. For example, the versions of the audio item may be provided by a content provider system, which dynamically generates the files containing the audio item to include dynamic content which can change from one iteration to another, in placement, content, length, and the like.

The flow diagram continues to block 720, where the media service 100 generates an audio item transcript for the audio item V1. As described above, the media service 100 may utilize speech-to-text to generate a transcript of the version of the audio item received as audio item V1. In some embodiments, the generated transcript may be mapped to the audio media item, for example, using timestamps corresponding to audio item V1, or the like. In addition, media service 100 can generate an audio item fingerprint for audio item V1. The media service 100 can additionally generate the audio item fingerprint to generate signatures for the audio item V1. For example, a single audio item fingerprint may be generated for the entire audio item. Alternatively, multiple individual audio item fingerprints can be generated for one or more segments of the audio item V1. According to some embodiments the one or more audio item fingerprints can be mapped to the audio item V1 using timestamps or other indicators of a temporal position of the audio media item corresponding to a particular audio item fingerprint or portion of the audio item fingerprint. The media service 100 may provide the V1 transcript and V1 fingerprint to client device A 120, as shown at block 725, and to client device N 140, as shown at block 730.

The flow diagram continues at block 735, where client device A 120 initiates a share for a particular moment A of the audio item. In some embodiments, the share request may be initiated from the media player such that the client device A 120 can share an indication of a particular segment or playback location at which playback should begin on the receiving device. In order to generate the share, the flow diagram continues to block 740, where a first audio drift is determined for the particular moment A between the version one of the audio items from which the transcript and fingerprint were generated, and the local version two of the audio item. According to some embodiments, the audio drift may be determined as a temporal distance between the moment in the two versions of the audio item and can be determined using techniques described above with respect to FIG. 6B and FIG. 6C. That is, the media player may iterate through guesses of a matched segment until a match is found.

Upon finding a match between the first version and the second version of the media item for the particular moment A, the flow diagram continues to block 745, and the client device A 120 sends the shared data for the audio item with the first audio drift data. In some embodiments, the shared data may be incorporated into a link, and may include the audio drift of the client device A 120 version of the audio item to the version of the audio item provided by the media service 100.

The flow diagram proceeds to block 755, and upon receiving the share data 750, the client device in 140 can determine an audio drift for the particular moment between the local third version of the audio item, and the first version of the audio item at the media service 100. That is, the share data 750 may indicate a portion of the audio item relative to the version of the audio item at the media service 100. Client device N 140 can additionally determine the difference between a local version of the audio item and the version of the audio item obtained by media service 100. The flow chart then concludes at block 760, where the client device in 140 initiates playback of the local version of the audio item based on the first audio drift and the second audio drift. In doing so, the portion of the media item selected by client device A 120 to share with client device N 140 will be consistent, even if the time stamps are different.

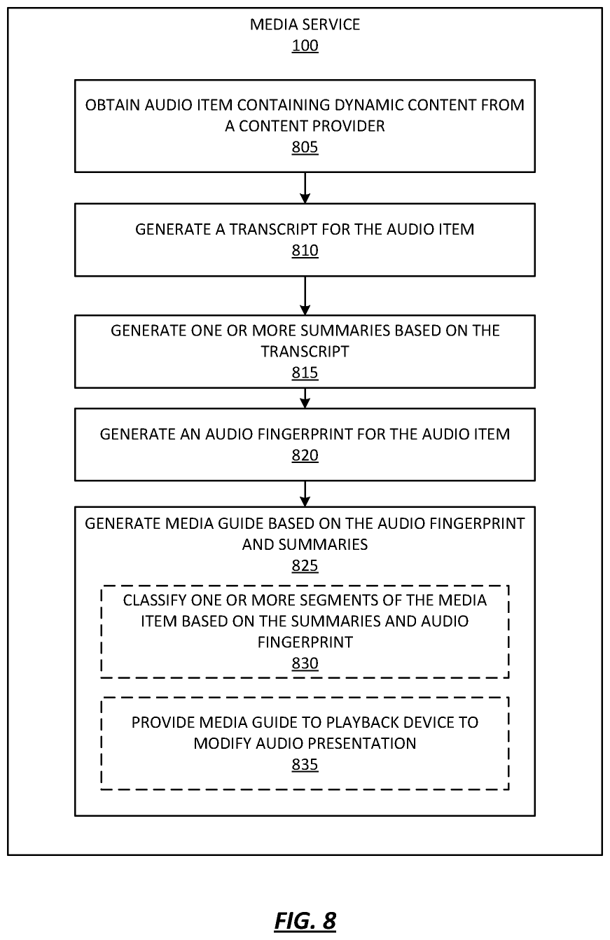

According to some embodiments, additional processing can be performed on the server provided transcripts to enable additional functionality. For example, one or more summaries can be generated from the transcripts, and mapped to the associated audio fingerprints. FIG. 8 shows, in flowchart form, a technique for generating a media guide using a transcript of an audio item and an associated audio fingerprint, in accordance with one or more embodiments. The various processes are described as being performed by media service 100. However, it should be understood that the various process can be performed by additional or alternative devices. Further, in some embodiments, the various processes could be performed by different devices communicably connected to media service 100. In addition, the various actions may be performed in a different order. Further, some actions may be performed simultaneously, and some may not be required, or others may be added.

The flow chart begins at block 805, where an audio item is obtained that contains dynamic content. The audio item may be obtained, for example, from a media platform configured to host audio items for distribution to one or more playback devices. For example, for the content provider may include network storage, the cloud system, or the like which is configured to host media items containing an audio component. The audio item may be obtained automatically, or upon request from the media service 100. The audio item may contain dynamic content which is generated prior to the audio item being provided to the media service 100. The dynamic content may include, for example, ancillary information about the media item, independent content interspersed within the audio item comment or the like.

The flow chart proceeds to block 810, where a transcript is generated for the audio item. According to our monuments, the transcript may be generated by the media service 100 by applying speech to text processing to the audio item. In some embodiments, additional or alternative processing may be performed, for example using machine learning models, may be applied to generate a transcript for the media item. The transcript may include, for example, a word-for-word representation of the content of the audio media item. And sometimes, the transcript may additionally include a mapping indicating a temporal guide between the transcript and the audio item. For example, timestamps may be used to indicate a portion of the audio item corresponding to a particular portion of the transcript. The flow chart proceeds to block 815, where one or more summaries are generated based on the transcript. The summaries may include, for example, descriptions of the audio content at particular portions, description of an entire audio item, or the like.

At block 820, an audio fingerprint is generated for the audio item. As described above, the audio fingerprint may comprise a unique acoustic signature of all or part of an audio media item. The signature may be obtained by applying the audio media item to a model or network which is trained to generate one or more audio signatures for the audio media item. In some embodiments, the audio fingerprint may capture a time-frequency distribution of the audio signal energy. Further, in some embodiment, the audio fingerprint may be a compact representation of the unique audio characteristics of the audio item, thereby reducing bandwidth requirements. In some embodiments, the audio fingerprint may be generated for the entire audio media item. Additionally, or alternatively, audio fingerprint data may be generated for segments or samplings of the audio media item. In some embodiments, the audio fingerprint may additionally include a mapping indicating a temporal guide between the transcript and the audio item. For example, timestamps may be used to indicate a portion of the audio item corresponding to a particular portion of the audio fingerprint.

The flow chart proceeds to block 825, where a media guide is generated based on the audio fingerprint and summaries. The media guide may provide an indication of the content at a particular portion of the audio item. For example, timestamps from the audio fingerprint and/or transcript may be used to identify the portion of the media item corresponding to the summary. Optionally, as shown at block 830, the summaries may be used to classify one or more segments of the media item. Examples of classifications may include topics discussed in the related portion of the media item, a relevance score for the media item based on the summary, and the like.

In some embodiments, the media guide may be provided to a playback device to modify the audio presentation. For example, the playback device may generate an audio trailer or preview for the audio media item using the summaries and/or the portions of the media item associated with the summaries, for example, by combining segments associated with high relevance scores. As another example, an audio media item may be dynamically shortened by the playback device by omitting the less relevant content. In some embodiments, the summaries may be generated across multiple audio items. For example, if an audio item is part of a collection of audio items, the summaries may be generated based on transcripts from more than one audio media item, thereby generating a summary of the full series or collection of audio media items.

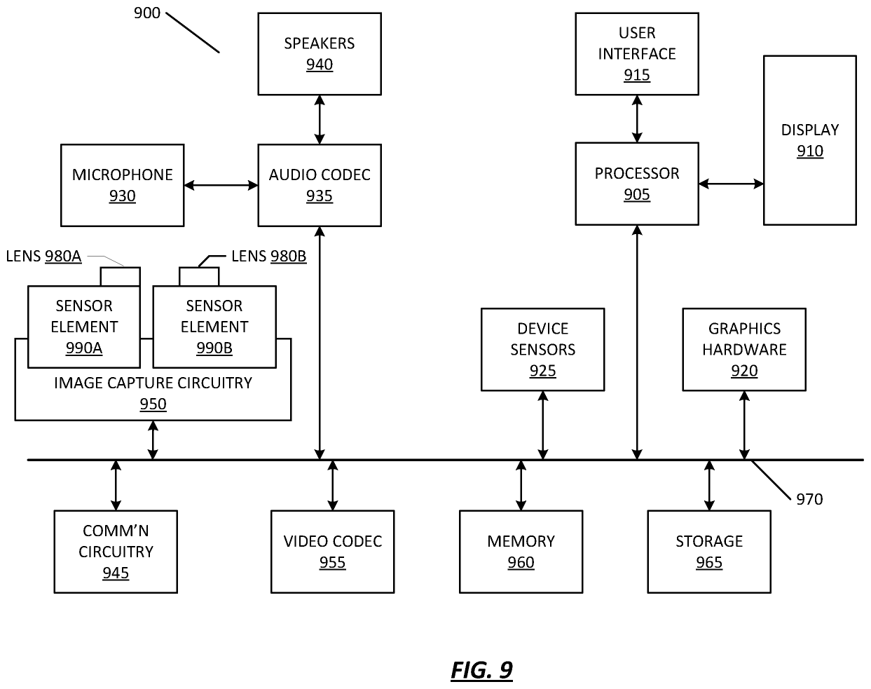

Referring now to FIG. 9, a simplified functional block diagram of illustrative multifunction device 900 is shown according to one embodiment. Multifunctional device 900 may show representative components, for example, for devices of media service 100, media service 100, and client device 140 of FIG. 1. Multifunction electronic device 900 may include processor 905, display 910, user interface 915, graphics hardware 920, device sensors 925 (e.g., proximity sensor/ambient light sensor, accelerometer and/or gyroscope), microphone 930, audio codec(s) 935, speaker(s) 940, communications circuitry 945, digital image capture circuitry 950 (e.g., including camera system) video codec(s) 955 (e.g., in support of digital image capture unit), memory 960, storage device 965, and communications bus 970. Multifunction electronic device 900 may be, for example, a digital camera or a personal electronic device such as a personal digital assistant (PDA), personal music player, mobile telephone, or a tablet computer.

Processor 905 may execute instructions necessary to carry out or control the operation of many functions performed by device 900 (e.g., such as the generation and/or processing of images as disclosed herein). Processor 905 may, for instance, drive display 910 and receive user input from user interface 915. User interface 915 may allow a user to interact with device 900. For example, user interface 915 can take a variety of forms, such as a button, keypad, dial, a click wheel, keyboard, display screen and/or a touch screen. Processor 905 may also, for example, be a system-on-chip such as those found in mobile devices and include a dedicated graphics processing unit (GPU). Processor 905 may be based on reduced instruction-set computer (RISC) or complex instruction-set computer (CISC) architectures or any other suitable architecture and may include one or more processing cores. Graphics hardware 920 may be special purpose computational hardware for processing graphics and/or assisting processor 905 to process graphics information. In one embodiment, graphics hardware 920 may include a programmable GPU.

Image capture circuitry 950 may include two (or more) lens assemblies 980A and 980B, where each lens assembly may have a separate focal length. For example, lens assembly 980A may have a short focal length relative to the focal length of lens assembly 980B. Each lens assembly may have a separate associated sensor element 990. Alternatively, two or more lens assemblies may share a common sensor element. Image capture circuitry 950 may capture still and/or video images. Output from image capture circuitry 950 may be processed, at least in part, by video codec(s) 955 and/or processor 905 and/or graphics hardware 920, and/or a dedicated image processing unit or pipeline incorporated within circuitry 965. Images so captured may be stored in memory 960 and/or storage 965.

Sensor and camera circuitry 950 may capture still and video images that may be processed in accordance with this disclosure, at least in part, by video codec(s) 955 and/or processor 905 and/or graphics hardware 920, and/or a dedicated image processing unit incorporated within circuitry 950. Images so captured may be stored in memory 960 and/or storage 965. Memory 960 may include one or more different types of media used by processor 905 and graphics hardware 920 to perform device functions. For example, memory 960 may include memory cache, read-only memory (ROM), and/or random-access memory (RAM). Storage 965 may store media (e.g., audio, image and video files), computer program instructions or software, preference information, device profile information, and any other suitable data. Storage 965 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 960 and storage 965 may be used to tangibly retain computer program instructions or code organized into one or more modules and written in any desired computer programming language. When executed by, for example, processor 905 such computer program code may implement one or more of the methods described herein.

The scope of the disclosed subject matter should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory computer readable medium comprising computer readable code executable by one or more processors to:
automatically generate, for a first version of an audio media item, a transcript and a first audio fingerprint indicative of audio characteristics of each of a set of segments of the first version of the audio media item.

2. The non-transitory computer readable medium of claim 1, further comprising computer readable code to:
provide the transcript and the first audio fingerprint to a playback device,
wherein the playback device presents the transcript during playback of a second version of the audio media item in accordance with a comparison of the first audio fingerprint and a second audio fingerprint for the second version of the audio media item.

3. The non-transitory computer readable medium of claim 2, wherein the first version of the audio media item comprises static content and first dynamic content, and wherein the second version of the audio media item comprises the static content and second dynamic content.

4. The non-transitory computer readable medium of claim 2, further comprising computer readable code to:
generate a summary of at least a portion of the transcript,
wherein the playback device performs playback of the second version of the audio media item based on the summary and portions of the first audio fingerprint associated with the summary.

5. The non-transitory computer readable medium of claim 4, wherein the playback devices generates a preview audio media item from the second version of the audio media item based on portions of the first version of the audio media item corresponding to the summary.

6. The non-transitory computer readable medium of claim 4, wherein the computer readable code to generate the summary of the at least the portion of the transcript further comprises computer readable code to:
automatically generate, for a second audio media item, an additional transcript, wherein the audio media item and the second audio media item are comprised in an audio media collection; and
generate a summary of the audio media collection based on the audio media item and the second audio media item.

7. The non-transitory computer readable medium of claim 1, further comprising computer readable code to:
generate a classification for at least one of the set of segments of the first version of the media item,
wherein the classification is usable to determine whether to play, skip, or replace a segment of the media item based on the classification.

8. The non-transitory computer readable medium of claim 6, further comprising computer readable code to:
generate a media guide for the audio media item based on the summary and the first audio fingerprint; and
provide the media guide to a playback device.

9. A non-transitory computer readable medium comprising computer readable code executable by one or more processors to:
receive a transcript for a first version of an audio media item, a first audio fingerprint indicative of audio characteristics of each of a set of segments of the first version the audio media item;
receive a second version of the audio media item;
generate a second audio fingerprint for the second version of the audio media item; and
present, during playback of the second version of the audio media item, the transcript in accordance with a comparison of the first audio fingerprint and the second audio fingerprint.

10. The non-transitory computer readable medium of claim 9, further comprising computer readable code to, in response to receiving user input at a particular portion of the presented transcript:
determine a first segment of the set of segments associated with the particular portion of the presented transcript; and
resume playback of the second version of the audio media item at a playback position based on a comparison of at least a portion of the first audio fingerprint associated with the first segment with the second audio fingerprint.

11. The non-transitory computer readable medium of claim 10, wherein the computer readable code to resume playback of the second version of the audio media item at the playback position further comprises computer readable code to:
construct an initial guess for the playback position based on the particular portion of the presented transcript and the first audio fingerprint; and
determine whether a portion of the second version of the audio media item corresponding to the initial guess based on a comparison of the first audio fingerprint for the initial guess and the second audio fingerprint for the initial guess.

12. The non-transitory computer readable medium of claim 9, wherein the first version of the audio media item comprises static content and first dynamic content, and wherein the second version of the audio media item comprises the static content and second dynamic content.

13. The non-transitory computer readable medium of claim 9, wherein a portion of the transcript is omitted from the presentation in accordance with the comparison.

14. The non-transitory computer readable medium of claim 9, wherein the second audio fingerprint is generated dynamically during playback of the second version of the audio item.

15. The non-transitory computer readable medium of claim 9, wherein the transcript and the first audio fingerprint are received from a first provider, and wherein the second version of the audio media item is received from a second provider.

16. A non-transitory computer readable medium comprising computer readable code executable by one or more processors to:
receive, at a local device, a playback request for an audio media item from a first device, wherein the playback request identifies a segment of a first version of the audio media item using a first audio fingerprint for the segment;
generate, by the local device, a second audio fingerprint for a second version of the media item; and
initiate, at a local device, playback at a location in the second version of the audio media item based on a comparison of the first audio fingerprint and the second audio fingerprint.

17. The non-transitory computer readable medium of claim 16, wherein the playback request comprises an indication of a first difference between the first audio fingerprint for the first segment and a server-generated audio fingerprint for a corresponding segment in a third version of the media item by the server, and further comprising computer readable code to:
determine a second difference between the second audio fingerprint and the server-generated audio fingerprint; and
initiate the playback at a location based on the first difference and the second difference.

18. The non-transitory computer readable medium of claim 17, wherein the computer readable code to determine the second difference comprises computer readable code to:
construct an initial guess for a playback position based on the first difference; and
determine whether a portion of the audio media item corresponds to the initial guess based on a comparison of the first audio fingerprint for the initial guess and the second audio fingerprint for the initial guess.

19. The non-transitory computer readable medium of claim 16, wherein the local device and the first device are associated with a same user profile.

20. The non-transitory computer readable medium of claim 16, wherein the first version of the audio media item comprises static content and first dynamic content, and wherein the second version of the audio media item comprises the static content and second dynamic content.
